(19) United States
(12) Patent Application Publication
(10) Pub. No.: US 2021/0147079 A1
(43) Pub. Date: May 20, 2021

(54) AUTONOMOUS BEHAVIOR GENERATION WITH HIERARCHICAL REINFORCEMENT LEARNING

(71) Applicant: HRL Laboratories, LLC, Malibu, CA (US)

(72) Inventors: Sean Soleyman, Calabasas, CA (US); Deepak Khosla, Camarillo, CA (US)

(21) Appl. No.: 17/064,566

(22) Filed: Oct. 6, 2020

Related U.S. Application Data
(63) Continuation-in-part of application No. 16/792,869, filed on Feb. 17, 2020.
(60) Provisional application No. 62/814,133, filed on Mar. 5, 2019.
(60) Provisional application No. 62/953,008, filed on Dec. 23, 2019.

(51) Int. Cl. B64C 39/02; G06N 3/08; G06N 3/04; G05B 13/02; G05D 1/02

(52) U.S. Cl. CPC B64C 39/024; G06N 3/08; B64C 2201/141; G05B 13/027; G05D 1/0202; G06N 3/0454

(57) ABSTRACT

Described is a system for autonomous behavior generation. The system includes both a high-level controller and a low-level controller. The high-level controller receives observations from an environment and, using a neural net, selects a high-level behavior based on the observations from the environment. The low-level controller generates an output command for a scripted action based on the selected one high-level behavior. After generating the output command, the system can implement an action, such as causing a device to perform the scripted action.

### CROSS-REFERENCE TO RELATED APPLICATION

This is a Continuation-in-Part application of U.S. application Ser. No. 16/792,869, filed on Feb. 17, 2020, which is a non-provisional patent application of U.S. Provisional Application No. 62/814,133 filed on Mar. 5, 2019, the entirety of which is hereby incorporated by reference.

The present application ALSO claims the benefit of and is a non-provisional patent application of U.S. Provisional Application No. 62/953,008, filed on Dec. 23, 2019, the entirety of which is hereby incorporated by reference.

### GOVERNMENT RIGHTS

This invention was made with government support under U.S. Government Contract Number HR0011-19-90018. The government has certain rights in the invention.

### BACKGROUND OF INVENTION

### (1) Field of Invention

The present invention relates to a learning system and, more specifically, to a learning system allowing for autonomous behavior generation using hierarchical reinforcement learning.

### (2) Description of Related Art

Reinforcement learning (RL) systems are employed in a variety of applications to learn from past decisions or scenarios in order to enhance new decision-making actions. Many researchers have attempted to improve the accuracy of such RL systems. By way of example, Dynamic Scripting is a related approach that was described by Pieter Spronck from Tilburg University. Specifically, Dynamic Scripting was described by Pieter Spronck, Marc Ponsen, Ida Sprinkhuizen-Kuyper, and Eric Postma (2006), in Adaptive Game AI with Dynamic Scripting. Machine Learning, Vol. 63, No. 3, pp. 217-248, (Springer DOI: 10.1007/s10994-006-6205-6), and by Armon Toubman, Jan-Joris Roessingh, Pieter Spronck, Aske Plaat, and Jaap van den Herik (2014), in Dynamic Scripting with Team Coordination in Air Combat Simulation, Proceedings of the 27th International Conference on Industrial, Engineering & Other Applications of Applied Intelligent Systems, Springer-Verlag, (Presented at the IEAAIE 2014 conference), both publications of which are incorporated herein by reference. Although Spronck et al. made some progress in RL systems, their approach uses machine learning models other than neural nets for high-level selection of behaviors. Such models are limited in their capacity for complex decision making.

In other work, U.S. Pat. No. 6,473,851 (the '851 Patent), titled “System for combining plurality of input control policies to provide a compositional output control policy” (also incorporated herein by reference), describes an approach with the same major limitation as Dynamic Scripting. Although the work as described in the '851 Patent incorporates stochastic mixing of policies, the resulting models are also limited in their capacity for complex decision making.

Thus, a continuing need exists for a system that uses specialized reinforcement learning techniques with integration of advanced neural net models to provide for complex high-level decision making.

### SUMMARY OF INVENTION

The present disclosure provides a system for autonomous behavior generation. In one aspect, the system includes one or more processors and one or more associated memories. Each associated memory is a non-transitory computer-readable medium having executable instructions encoded thereon such that when executed, an associated one or more processors perform several operations, including receiving, by a high-level controller, observations from an environment and, using a neural net, selecting a high-level behavior based on the observations from the environment; generating, by a low-level controller, an output command for a scripted action based on the selected one high-level behavior; and causing a device to perform the scripted action.

In yet another aspect, the system performs an operation of training the neural net using reinforcement learning.

In another aspect, causing a device to perform the scripted action includes controlling aircraft in a flight scenario.

In yet another aspect, the system performs an operation of using a softmax learning function to train a reinforcement learning agent within the high-level controller to produce probabilities of selecting different high-level behaviors.

In another aspect, the same neural net that selects behaviors also produces a state value output for use as a reinforcement learning baseline or for reinforcement learning bootstrapping.

In yet another aspect, the system further comprises a second neural net that produces a state value output for use as a reinforcement learning baseline or for reinforcement learning bootstrapping.

In yet another aspect, the neural net produces action value outputs based on the environment observations, and wherein the high-level controller selects the high-level behavior using a softmax function on the action value outputs.

Further, the high-level controller selects behaviors at a lower frequency than a frequency at which the low-level controllers select scripted actions.

In another aspect, an additional set of neural nets is trained with reinforcement learning so that each neural net determines how long to run one of the high-level behaviors.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system according to various embodiments of the present invention;

FIG. 2 is an illustration of a computer program product embodying an aspect of the present invention;

FIG. 3 is a flowchart depicting a high-level controller having of a policy neural net with reinforcement learning trainer, and a low-level controller that produces actions corresponding to the selected behavior;

FIG. 4 is an illustration depicting pseudocode for a desired embodiment with a high-level reinforcement learning agent and scripted behaviors;

FIG. 5 is an illustration depicting a high-level selection of behaviors and corresponding low-level controller decisions that produce directional controls that are used to adjust an autonomous platform's headings;

FIG. 6 is an illustration depicting an aspect with additional neural nets that restrict times at which the high-level controller can switch to a different behavior;

FIG. 7 is a table depicting an action space;

FIG. 8 is a graph depicting experimental results in a simple scenario with a simulator;

FIG. 9 is a block diagram depicting control of a device according to various embodiments;

FIG. 10 is an illustration depicting an aspect that includes a single neural net according to various embodiments;

FIG. 11 is an illustration depicting example pseudocode according to various embodiments; and

FIG. 12 is an illustration depicting example pseudocode according to various embodiments.

### DETAILED DESCRIPTION

The present invention relates to a learning system and, more specifically, to a learning system allowing for autonomous behavior generation using hierarchical reinforcement learning. The following description is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112(f). In particular, the use of “step of” or “act of” in the claims herein is not intended to invoke the provisions of 35 U.S.C. 112(f).

Before describing the invention in detail, first a description of the various principal aspects of the present invention is provided. Subsequently, an introduction provides the reader with a general understanding of the present invention. Finally, specific details of various embodiment of the present invention are provided to give an understanding of the specific aspects.

### (1) Principal Aspects

Various embodiments of the invention include three “principal” aspects. The first is a system for autonomous behavior generation with hierarchical reinforcement learning. The system is typically in the form of a computer system operating software or otherwise performing operations or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

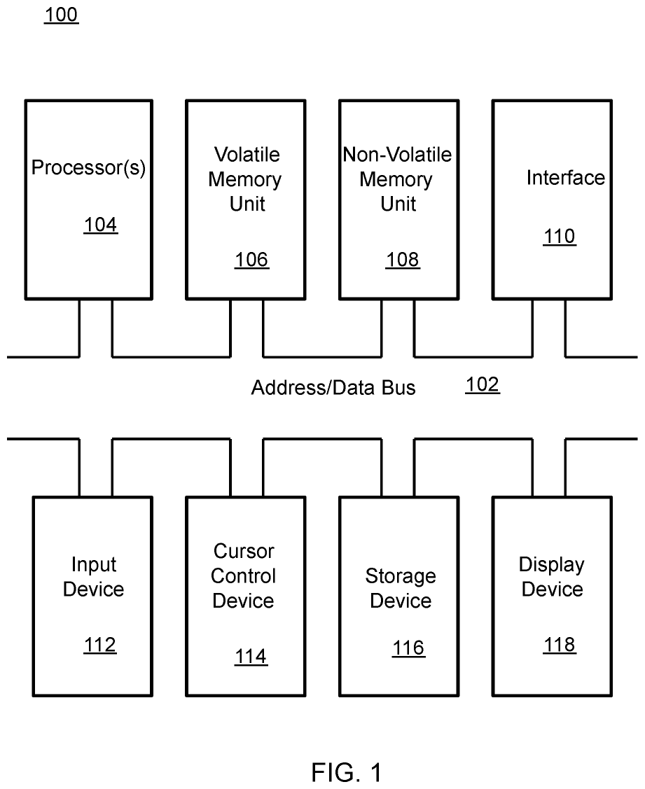

A block diagram depicting an example of a system (i.e., computer system 100) of the present invention is provided in FIG. 1. The computer system 100 is configured to perform calculations, processes, operations, and/or functions associated with a program or algorithm or other means for causing one or more processors to perform the relevant operations. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein. In various aspects, the computer system 100 can be embodied in any device(s) that operates to perform the functions as described herein as applicable to the particular application, such as a desktop computer, a mobile or smart phone, a tablet computer, a computer embodied in a mobile platform, or any other device or devices that can individually and/or collectively execute the instructions to perform the related operations/processes.

The computer system 100 may include an address/data bus 102 that is configured to communicate information. Additionally, one or more data processing units, such as a processor 104 (or processors), are coupled with the address/data bus 102 and/or associated memory to cause the one or more processors 104 to perform the operations as described herein. The one or more processors 104 are configured to process information and instructions and to cause the related operations to be performed, such as operating the high-level and low-level controllers as described in further detail below. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA) or any other processing component operable for performing the relevant operations.

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 104. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 104. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

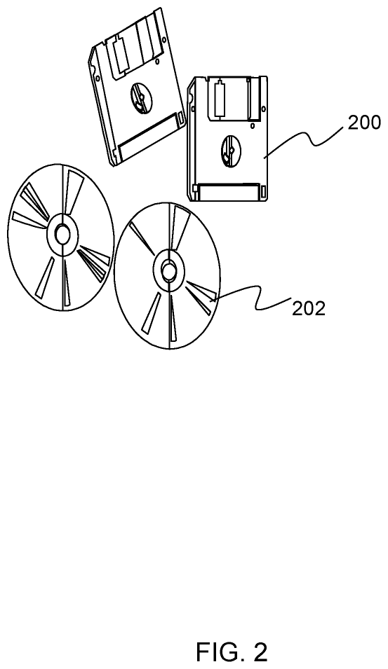

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

### (2) Introduction

As noted above, the present disclosure provides a learning system allowing for autonomous behavior generation using hierarchical reinforcement learning. The learning system is implemented as a control system having two different but complementary components (i.e., a high-level component and a low-level component) that work together to produce complex autonomous behaviors for autonomous platforms such as vehicles and other robotic systems. The high-level component uses a deep neural net to determine optimal probabilities for making a selection from a set of available behaviors. The low-level component uses traditional rule-based artificial intelligence (AI) to produce control outputs (commands) that cause the autonomous platform to generate the selected behavior. In some aspects, the low-level component can also be implemented as a machine learning system with one or more additional deep neural networks.

As can be appreciated, there are many applications of the system and process as described herein. For example, the system can be implemented in autonomous air-to-air engagement systems, as well as for simulation software that is used to model air-to-air engagements for training or decision-making purposes. Experimental results in a simulator have shown that this invention produces an order of magnitude training speedup over existing solutions that utilize a traditional non-hierarchical reinforcement learning architecture. In addition, this invention can be applied to new problems more easily than current state-of-the-art reinforcement learning methods because it can be used with a simple sparse reward function, instead of a complicated dense reward function that requires hand-engineering and trial-and-error experimentation whenever the system is used in a new environment. As an additional potential application, the system may be incorporated into autonomous cars and trucks. In this case, high-level behaviors might consist of driving down a road, performing an emergency stop, or making a turn at an intersection. The low-level behaviors for a ground vehicle would consist of steering, acceleration, and braking commands as well as associated turn signals, transmission shifts, etc. Specific details regarding the invention are provided below.

### (3) Specific Details of Various Embodiments

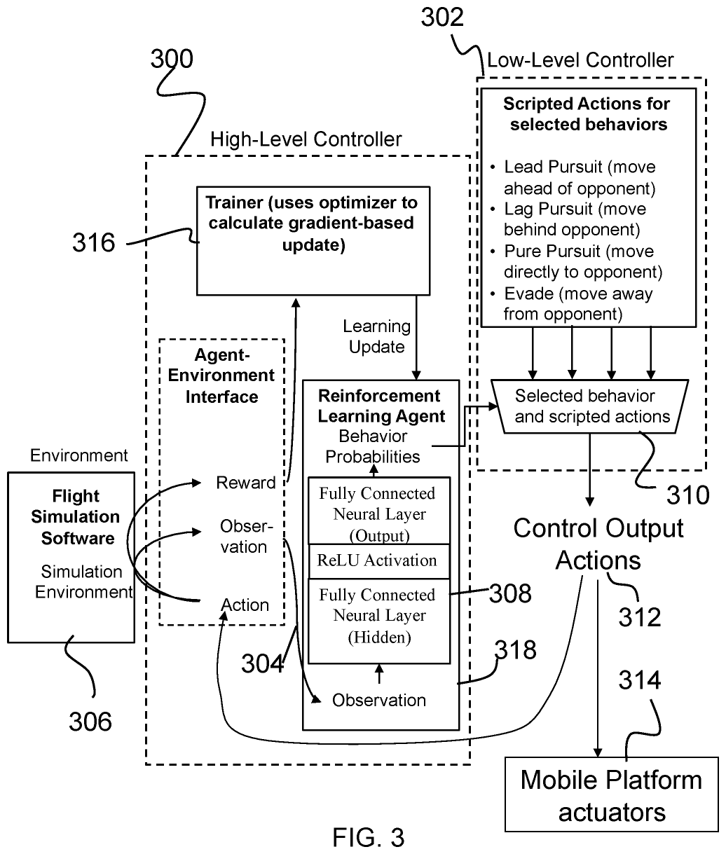

As shown in FIG. 3, the present disclosure provides a high-level controller 300 and a low-level controller 302. The high-level controller 300 takes in observations 304 from an environment 306 (either simulated or real), and uses a neural net 308 to select high-level behaviors based on behavior probabilities. The ability to select high-level behaviors based on behavior probabilities is well known to those skilled in the art of machine learning. By way of example, an open source software may be used to implement the neural net that performs high-level behavior selection, such as the TensorFlow Core r1.15 Module: tf software provided by tensorflow.org.

The neural net 308 is a fully-connected network that multiplies the input observation vector by a learnable weight matrix, adds a learnable bias vector to the result, applies a nonlinear function such as Rectified Linear Unit (ReLU) to this result, and then repeats the process for each neuron layer by applying the result from the previous layer as input. The final layer produces one output for each possible high-level behavior, and it does not apply an element-wise nonlinearity like ReLU to the result. Instead, it samples an integer from the softmax distribution defined by these outputs. The high-level behavior indexed by this integer is then selected. The use of the softmax activation in the final layer instead of ReLU is well-known to machine learning practitioners and those skilled in the art. ReLU is not used in the final layer because this would result in action probabilities that do not sum to one. In contrast, the softmax operation produces a probability distribution where all of the probabilities are guaranteed to sum to one. Each output of the neural network influences the relative probability of selecting the corresponding action.

Non-limiting examples of such high-level behaviors include “lead pursuit,” “lag pursuit,” “pure pursuit,” or “evade.” Other examples include “maintain position”, stop”, “swerve”, “avoid collision,” etc. Thus, it should be appreciated that the specific behavioral options depend on the application in which the system is implemented. Once the behavior has been selected 310 and passed to the low-level controller, the low-level controller 302 produces output actions 312 (scripted behaviors) that have direct control over the system's motion. Thus, the output actions 312 are commands or signals that are, in some aspects, sent to the mobile platform's actuators 314 (wheels, motors, engines, wing flaps, rotors, etc.) to cause the mobile platform to perform the scripted behavior. For example, if an autonomous aircraft in a one-versus-one engagement scenario selects “pure pursuit,” the low-level controller will generate signals that direct the plane to head or otherwise fly directly towards its opponent. Other examples of scripted behaviors include “lag pursuit” (move behind opponent), “lead pursuit” (move ahead of opponent, and “evade” (move away from opponent). In an alternative embodiment, the low-level component 302 can also be implemented using a deep neural network.

The high-level controller's neural net 308 is trained using a reinforcement learning agent 318 in conjunction with a trainer 316. For each training episode, the system keeps track of the high-level behaviors it has selected, the observations that resulted from applying the corresponding low-level actions to the environment, and the rewards that were obtained from the same environment's reward function. After each episode has been completed, a trainer 316 uses some variant of a gradient descent optimizer to update the neural net 308 connection weights in a way that increases the expected value of future rewards. As a non-limiting example, an RMSProp gradient descent optimizer is used to update the neural net connection weights with learning rate 0.0007, momentum 0, and epsilon 1e-10. The RMSProp gradient descent optimizer is well known to those skilled in the art of machine learning. By way of example, an open source RMSProp gradient descent optimizer may be found at www.tensorflow.org. Other optimizers, such as Momentum, Nesterov, Adam, or AdaGrad could just as easily be used.

A desired embodiment uses A3C (Asynchronous Advantage Actor Critic) to parallelize the execution of episodes during training by the trainer 316. This is described in “Asynchronous Methods for Deep Reinforcement Learning” by Mnih et. al., Proceedings of The 33rd International Conference on Machine Learning, PMLR 48:1928-1937, 2016, the entirety of which is incorporated herein by reference. Thus, in some aspects, the trainer 316, using a softmax function, trains the reinforcement learning agent 318 to product probabilities of selecting different behaviors. Other policy-based reinforcement learning algorithms could also have been used instead of Actor-Critic, such as: A2C, PPO, TRPO, ACKTR, IMPALA, DDPG, and TD3.

Some of these methods, including the desired embodiment that uses A3C, include a value net in addition to the policy net. This minor detail should be familiar to those with knowledge of reinforcement learning. In the present example, two separate networks were used, each with a single hidden layer of 36 neurons and ReLU activation. Alternatively, it is also possible to use a combined network with two outputs—one to produce action probabilities, and one to provide a value function. In yet another alternative embodiment, it would be possible to use a value-based method such as Q-learning, in which case the policy net would be replaced by a value net and an epsilon-greedy policy.

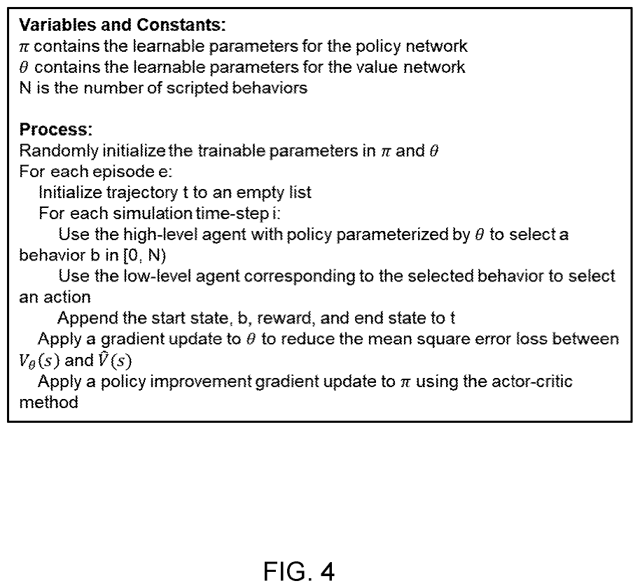

As a specific example implementation, FIG. 4 provides example pseudocode for a desired embodiment with a high-level reinforcement learning agent and low-level scripted behaviors. It should be understood that although a specific example of pseudocode is provided, other example code or pseudocode can be implemented to provide the operations as described herein. The high-level reinforcement learning agent makes a selection from the various scripted behaviors. They are actually high-level behaviors that produce low-level behaviors. For example, the high-level agent may select “pure pursuit,” a high-level behavior. A scripted rule (for example, a control law similar to those used in missile guidance systems) converts this to a low-level behavior, such as moving the ailerons to roll the plane while moving the elevator to command a certain angle of attack.

Further, provided herein are four alternative embodiments or aspects, each of which provides a mechanism that restricts the times at which the high-level controller is given a choice to switch to a different behavior. It should be understood that the alternative embodiments are can be implemented in air engagement or any other autonomous vehicle applications or other applications as applicable.

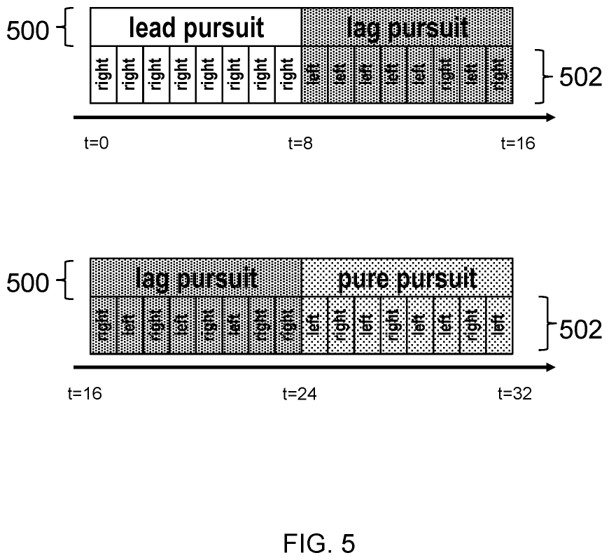

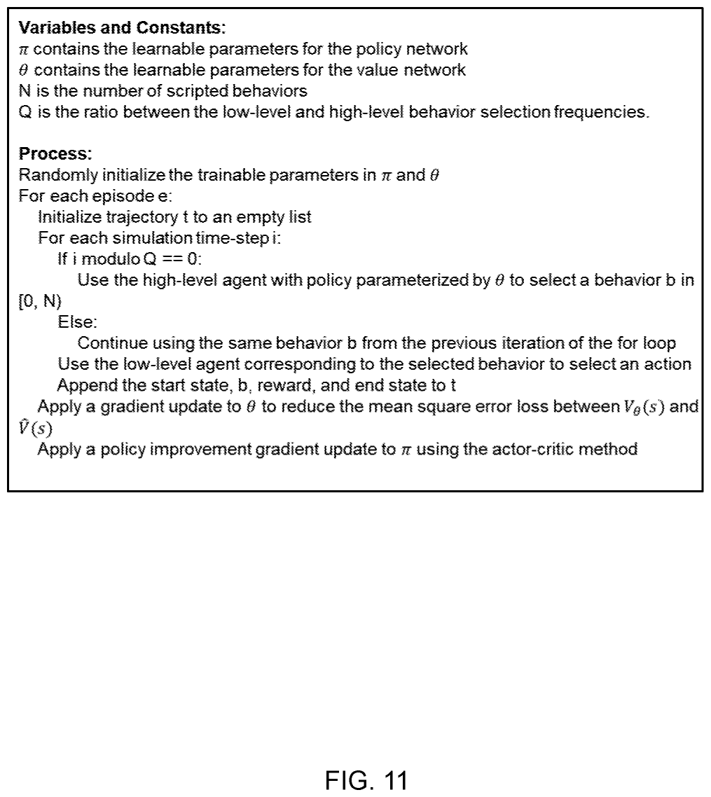

The first alternative (example pseudocode of which is depicted in FIG. 11) still performs high-level behavior selection at a fixed frequency, but this frequency is lower than the update rate of the low-level controller. This has been shown to provide a slight improvement in performance over the preferred embodiment, at the expense of increased complexity. Specifically, FIG. 5 provides an example of high-level selection of behaviors 500 (e.g., lag pursuit, pure pursuit, and lead pursuit) at a frequency that is ⅛ of the low-level controller's 502 frequency. In this non-limiting example, the low-level controller 502 produces specific scripted actions (e.g., turn directions (left/right)) that are used to adjust a mobile platform's heading. An alternative embodiment can be employed with additional neural nets that restrict the times at which the high-level controller can switch to a different behavior.

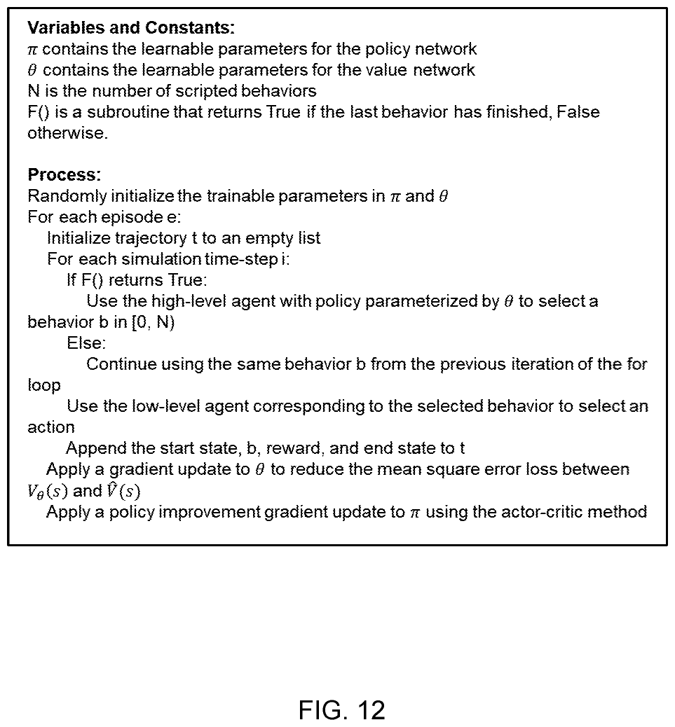

Another alternative embodiment (example pseudocode of which is depicted in FIG. 12) uses traditional rule-based AI to specify a termination condition for each behavior. Once a behavior has been selected, execution will continue until this termination condition has been reached, at which time the high-level controller will select a new behavior.

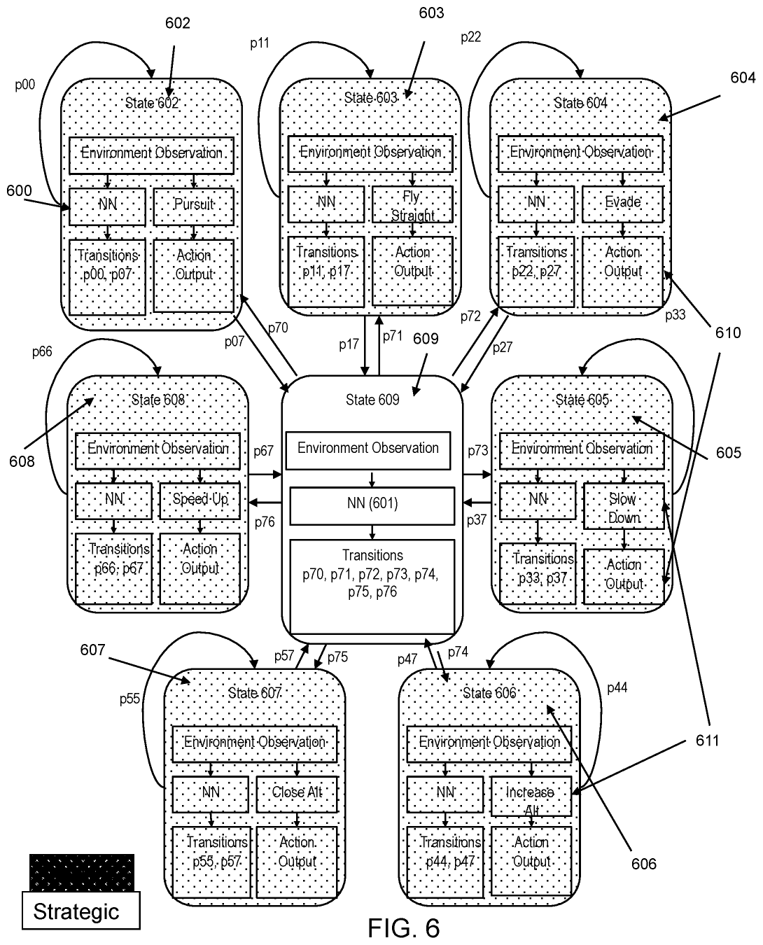

Yet another alternative aspect is shown in FIG. 6. The aspect as illustrated in FIG. 6 includes additional neural nets 600, one for each tactical state 602-608. Note that the states listed below are provided with specific example implementations; however, the invention is not intended to be limited thereto as any suitable state or action can be implemented given the particular application. Also shown in FIG. 6 are the state transition probabilities between the tactical states. These neural nets 600 are in addition to the strategic neural net 601 that makes a selection from the set of 7 available tactical states (each corresponding to one of 7 specific behaviors) as described herein and illustrated. The neural nets 600 restrict the times at which the high-level controller 601 can switch to a different behavior. Each time the selected low-level controller produces an output action 610, its corresponding neural net 600 produces probabilities for continuing with the current behavior, or for handing control back to the high-level controller 601 that may decide to switch to a different behavior. The overall behavior of this aspect is best described in terms of a state machine. The system starts out in state 609, which means that the behavior has not yet been selected. It transitions from this state to one of states 602-608, with probability determined by applying the softmax function to the output of strategic neural net 601. Once the system is in a tactical state 602-608, it performs the high-level behavior corresponding to that particular state 611. For example, the “slow down” behavior will set the aircraft's target speed to a value 5 m/s lower than its current value. The “pursuit” behavior causes the aircraft to turn in the direction of the opponent. The “evade” behavior causes the aircraft to turn away from the opponent. After each time-step, the tactical neural net 600 corresponding to the current state 602-608 is used to determine probabilities of staying in the current state, or of transitioning back to state 609. In the first case, it will be guaranteed to continue the current behavior. In the second case, it the strategic neural net 601 selects a state 602-608 corresponding to a new behavior and the process repeats. Since the tactical nets 600 only output two probabilities (which sum to 1), it uses a logistic output instead of a softmax output. The probability of transitioning back to 609 is calculated by applying the logistic function to a single-neuron output of 600, and the probability of staying in the current state is determined by subtracting one minus this probability. The logistic function is a well-known method (similar to softmax) for getting a neural network to produce a probability distribution. In this case there are only two possible alternatives (transition back or remain), so a neural network with a single output neuron and a logistic function is used. Since the output of the logistic function is always between zero and one, it is guaranteed to be a valid probability. Since probabilities must sum to one, the system can then find the probability of remaining by subtracting one minus the probability of transitioning. It should be understood that all of the high-level behaviors or “strategies” are the same as they were in the desired embodiment—e.g. “lead pursuit,” “lag pursuit,” “pure pursuit,” “evade,” etc. The decision being made by the “tactical” networks pertains to the question of precise timing—each “tactical” network specifies the conditions at which to end the corresponding behavior.

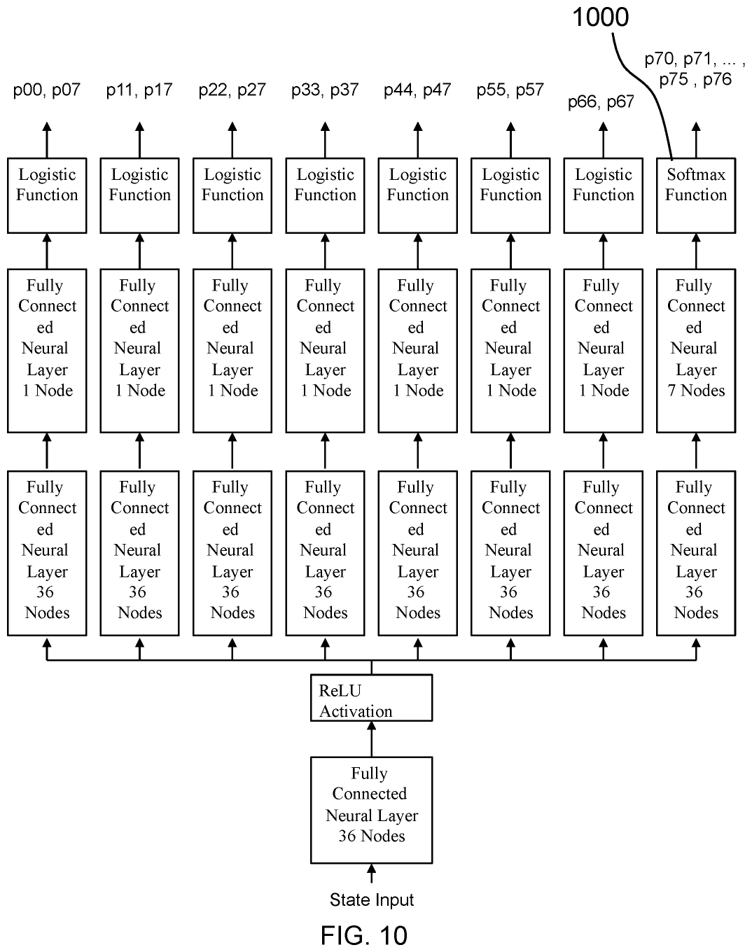

Another alternative aspect is similar to the previous aspect; however, this aspect uses a single neural net with multiple outputs instead of separate neural nets. As shown in FIG. 10, this single neural network produces all of the transition probabilities needed to make the decision of which behavior state (e.g., elements 602-608 as shown in FIG. 6) to select (with probabilities for each state p70, p71, . . . , p75, p76) as well as whether to continue the current behavior state (with probability p00, p11, . . . , p55, p66) or transition to a new behavior state (with probability p07, p17, . . . , p57, p67). The states correspond to high-level behaviors. The lowest-level behaviors for aircraft consist of direct control of flying surfaces. For example, the low-level behavior corresponding to a high-level “pure pursuit” would involve rolling the plane in the direction of the opponent and raising the elevator to increase the angle of attack so as to point towards the opponent. For deciding between the 7 available behaviors, a neural network head 1000 with a softmax activation function is used. However, for deciding whether to stay in the current behavior state or transition to the strategic state 609, a logistic function is used to determine the probability of transitioning to 609 and one minus this probability to determine the probability of staying with the current behavior state 602-608.

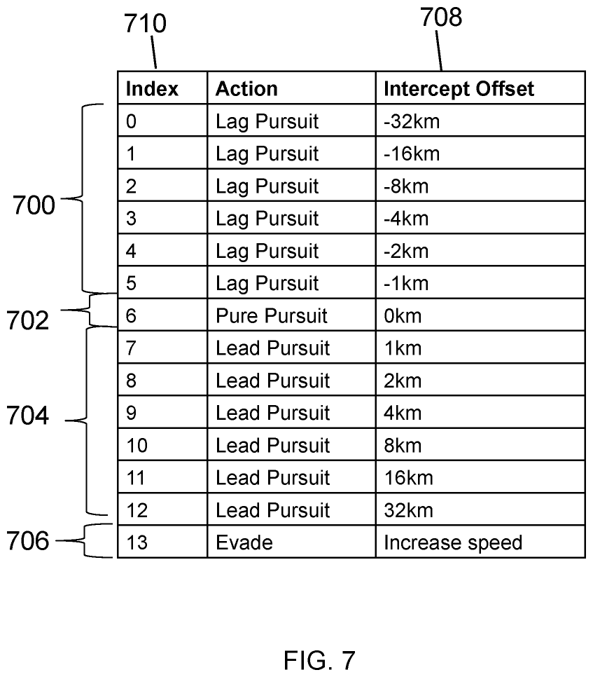

Experiments were performed using a simulated environment. The simulator modeled the movement of two or more aircraft in a two-dimensional map. In an example embodiment, the policy network selects one of 14 possible discrete actions for the platform that it is controlling, as shown in FIG. 7.

The neural net's softmax output layer produces an integer from 0 to 13. This integer corresponds to the “index” column in FIG. 7. This index specifies whether to perform a lead pursuit, lag pursuit, pure pursuit, or evade, but in the first two cases, also specifies the amount of lead or lag. When the neural net selects an index from 0 to 5, triggering a lag pursuit behavior 700, it causes the platform that it is controlling to pursue a point behind its opponent (as a negative intercept offset 708). Pure pursuit 702 and lead pursuit 704 are similar, except that the point is at or in front of the target in each respective case. The evade action 706 causes the platform to turn away from its opponent and increase speed as much as possible so that it can escape. Each platform's weapon engagement zone is modeled as a simple circle sector defined by a radius and a central angle. In an experiment, the radius of this zone was set to 2 kilometers, and the central angle was set to 30 degrees. Each episode ended when one of the platforms entered the other's weapon engagement zone, at which point a reward of +5000 was given to the platform in firing position, and −5000 to the platform that was about to be fired upon. If neither platform entered the other's engagement zone within 1000 timesteps, a draw was declared and each platform received no reward (value of zero).

In reinforcement learning applications, it is typical for the environment to provide the agent with a more informative “dense reward” function that provides a more continuous spectrum of outcome desirability than just win or loss. For example, some of previous experiments without the hierarchical approach used a reward function that included a small reward for getting closer to the opponent at each step, even if victory was not ultimately achieved. This was necessary to bootstrap learning. Otherwise, the probability of an un-trained platform ever reaching its opponent was too low, few rewards were obtained, and the policy never even started to improve. However, one surprising advantage of the new hierarchical approach is that now, a simple sparse reward function provides sufficient feedback to train the agent from scratch. This makes the method much easier to apply to new scenarios/decision making environments because it eliminates the need for trial-and-error reward function engineering.

In addition to the reward, the environment also provides each agent with its opponent's distance, closing speed, bearing, heading, and cross speed after each simulation time-step. This allows the agent to select an action based on the current observed state of the environment.

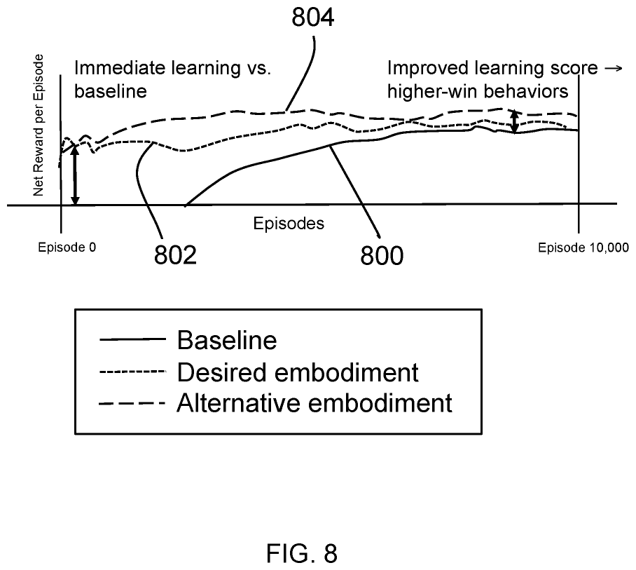

Experimental results are shown in FIG. 8, depicting a simple scenario performed with a simulator that provides 10,000 episodes mapped from a starting point. The baseline 800 result uses pure reinforcement learning. It takes approximately 2,500 episodes of experience before the agent learns to win more episodes than it loses. In contrast, a desired embodiment 802 of this invention uses one of its scripted policies to achieve learning that appears almost instantaneous by comparison. Indeed, the prior knowledge encoded in the scripted policy greatly simplifies the reinforcement learning task. An alternative embodiment 804 was also experimented with, where the high-level behavior is selected 256 times less frequently than the low-level action. This makes it even easier for the reinforcement learning module to find a winning strategy, because it only needs to select a behavior four times per episode instead of 1000 times (assuming that each episode lasts for 1000 steps). These results demonstrate that the novel method has advantages over both of the simpler methods upon which it is built. It can be much faster than reinforcement learning with a flat architecture, and more effective than a simple scripted (traditional) AI opponent.

(3.1) Control of a Device

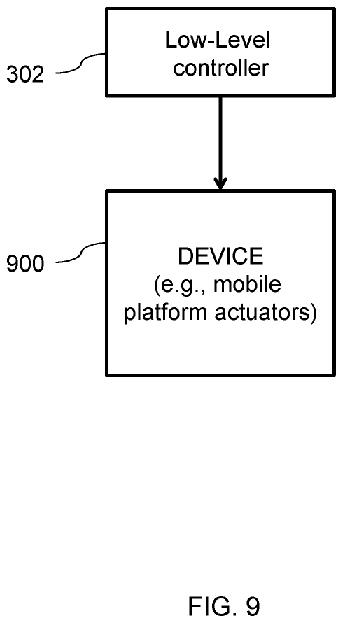

As shown in FIG. 9, the low-level controller 302 generates a command signal to allow the system (via one or more processors, etc.) to control a device 900 (e.g., a mobile device display, a virtual reality display, an augmented reality display, a computer monitor, a motor, engines, a machine, a drone, a camera, etc.). The control of the device 900 may be used to cause the device to move or otherwise initiate a physical action based on the scripted action (i.e., execute the scripted action).

In the primary embodiment, an Unmanned Air Vehicle (UAV) or drone—either one that is simulated on a computer or a real one with hardware actuators connected to the system herein described—may be controlled using a set of behaviors that are selected using the high-level controller. One such behavior implements a guidance law (e.g. proportional navigation) that causes the controlled aircraft to pursue another aircraft, based on the relative position, orientation, and/or velocity of the second aircraft as determined using radar, a visual camera, infrared camera, acoustic sensor, LIDAR, or any other sensor that can provide this information. Instead of a single pursuit behavior, it is also possible to have multiple lead, lag, and pure pursuit behaviors from FIG. 7. An evade behavior can also be included. When this behavior is selected, it activates a guidance rule that causes the aircraft to increase its distance from aircraft that are perceived using the aircraft's sensors. A weapon firing behavior, when selected, would cause the aircraft to initiate a series of actuator movements and/or ignitions that activate a weapon such as a gun or missile with the goal of destroying or otherwise disabling the other aircraft. A weapon support behavior, when selected, would cause the aircraft to maintain a position that allows it to illuminate an enemy aircraft with its radar transmitter to provide support for a radar-guided missile. Any other typical aircraft procedure or maneuver that can be automated using a series of actuator movements could be included in the set of available behaviors.

In some embodiments, a drone or other autonomous vehicle may be controlled to move to an area where the localization of the object is determined to be based on imagery obtained from the environment. In yet some other embodiments, a camera may be controlled to orient towards or track an object. In other words, actuators or motors are activated to cause the camera (or sensor) to move or zoom in on the location where the object is localized. In yet another aspect, if a system is seeking a particular object and if the object is not determined to be within the field-of-view of the camera, the camera can be caused to rotate or turn to view other areas within a scene until the sought after object is detected.

In addition, in a non-limiting example of an autonomous vehicle having multiple sensors, such as cameras that can be used to detect objects in an environment around the vehicle, the system can cause the autonomous vehicle to perform a vehicle operation. For instance, if the vehicle sensors detect an object in the vehicle's pathway, the system can be used to cause a precise vehicle maneuver (scripted action) for collision avoidance by controlling a vehicle component. For example, if the vehicle is an automobile and the object is a stop sign, the system may cause the autonomous vehicle to apply a functional response, such as a braking operation, to stop the vehicle. Other appropriate responses may include one or more of a steering operation, a throttle operation to increase speed or to decrease speed, or a decision to maintain course and speed without change. The responses may be appropriate for avoiding a collision, improving travel speed, or improving efficiency.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for autonomous behavior generation, the system comprising:
one or more processors and one or more associated memories, each associated memory being a non-transitory computer-readable medium having executable instructions encoded thereon such that when executed, an associated one or more processors perform operations of:
receiving, by a high-level controller, observations from an environment and, using a neural net, selecting a high-level behavior based on the observations from the environment;
generating, by a low-level controller, an output command for a scripted action based on the selected one high-level behavior; and
causing a device to perform the scripted action.

2. The system as set forth in claim 1, further comprising an operation of training the neural net using reinforcement learning.

3. The system as set forth in claim 1, wherein causing a device to perform the scripted action includes controlling aircraft in a flight scenario.

4. The system as set forth in claim 1, further comprising an operation of using a softmax learning function to train a reinforcement learning agent within the high-level controller to produce probabilities of selecting different high-level behaviors.

5. The system as set forth in claim 1, wherein the same neural net that selects behaviors also produces a state value output for use as a reinforcement learning baseline or for reinforcement learning bootstrapping.

6. The system as set forth in claim 1, further comprising a second neural net that produces a state value output for use as a reinforcement learning baseline or for reinforcement learning bootstrapping.

7. The system as set forth in claim 1, wherein the neural net produces action value outputs based on the environment observations, and wherein the high-level controller selects the high-level behavior using a softmax function on the action value outputs.

8. The system as set forth in claim 1, wherein the high-level controller selects behaviors at a lower frequency than a frequency at which the low-level controllers select scripted actions.

9. The system as set forth in claim 1, wherein an additional set of neural nets is trained with reinforcement learning so that each neural net determines how long to run one of the high-level behaviors.

10. A computer program product for autonomous behavior generation, the computer program product comprising:
a non-transitory computer-readable medium having executable instructions encoded thereon, such that upon execution of the instructions by one or more processors, the one or more processors perform operations of:
receiving, by a high-level controller, observations from an environment and, using a neural net, selecting a high-level behavior based on the observations from the environment;
generating, by a low-level controller, an output command for a scripted action based on the selected one high-level behavior; and
causing a device to perform the scripted action.

11. The computer program product as set forth in claim 10, further comprising instructions encoded on the non-transitory medium for causing the one or more processors to perform an operation of training the neural net using reinforcement learning.

12. The computer program product as set forth in claim 10, wherein causing a device to perform the scripted action includes controlling aircraft in a flight scenario.

13. The computer program product as set forth in claim 10, further comprising instructions encoded on the non-transitory medium for causing the one or more processors to perform an operation of using a softmax learning function to train a reinforcement learning agent within the high-level controller to produce probabilities of selecting different high-level behaviors.

14. The computer program product as set forth in claim 10, wherein the same neural net that selects behaviors also produces a state value output for use as a reinforcement learning baseline or for reinforcement learning bootstrapping.

15. The computer program product as set forth in claim 10, further comprising instructions encoded on the non-transitory medium for causing the one or more processors to use a second neural net to produces a state value output for use as a reinforcement learning baseline or for reinforcement learning bootstrapping.

16. The computer program product as set forth in claim 10, wherein the neural net produces action value outputs based on the environment observations, and wherein the high-level controller selects the high-level behavior using a softmax function on the action value outputs.

17. The computer program product as set forth in claim 10, wherein the high-level controller selects behaviors at a lower frequency than a frequency at which the low-level controllers select scripted actions.

18. The computer program product as set forth in claim 10, wherein an additional set of neural nets is trained with reinforcement learning so that each neural net determines how long to run one of the high-level behaviors.

19. A computer implemented method for autonomous behavior generation, the method comprising an act of:
causing one or more processers to execute instructions encoded on a non-transitory computer-readable medium, such that upon execution, the one or more processors perform operations of:
receiving, by a high-level controller, observations from an environment and, using a neural net, selecting a high-level behavior based on the observations from the environment;
generating, by a low-level controller, an output command for a scripted action based on the selected one high-level behavior; and
causing a device to perform the scripted action.

20. The method as set forth in claim 19, further comprising an operation of training the neural net using reinforcement learning.

21. The method as set forth in claim 19, wherein causing a device to perform the scripted action includes controlling aircraft in a flight scenario.

22. The method as set forth in claim 19, further comprising an operation of using a softmax learning function to train a reinforcement learning agent within the high-level controller to produce probabilities of selecting different high-level behaviors.

23. The method as set forth in claim 19, wherein the same neural net that selects behaviors also produces a state value output for use as a reinforcement learning baseline or for reinforcement learning bootstrapping.

24. The method as set forth in claim 19, further comprising a second neural net that produces a state value output for use as a reinforcement learning baseline or for reinforcement learning bootstrapping.

25. The method as set forth in claim 19, wherein the neural net produces action value outputs based on the environment observations, and wherein the high-level controller selects the high-level behavior using a softmax function on the action value outputs.

26. The method as set forth in claim 19, wherein the high-level controller selects behaviors at a lower frequency than a frequency at which the low-level controllers select scripted actions.

27. The method as set forth in claim 19, wherein an additional set of neural nets is trained with reinforcement learning so that each neural net determines how long to run one of the high-level behaviors.
